(19) United States
(12) Patent Application Publication
(10) Pub. No.: US 2003/0177229 A1
(43) Pub. Date: Sep. 18, 2003

(54) Microcomputer, bus control circuit, and data access method for a microcomputer

(75) Inventor: Nobuhiko Akasaka, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/369,524

(22) Filed: Feb. 21, 2003

(30) Foreign Application Priority Data
Mar. 18, 2002 (JP) 2002-073919

(51) Int. Cl. G06F 15/173; G06F 15/16

(52) U.S. Cl. 709/224; 709/253

(57) ABSTRACT

A microcomputer capable of efficiently accessing a plurality of devices with different access speeds through a shared bus. If, during access to a first device in compliance with a first access request, a second access request for a second device is issued from a CPU, an access completion time determination section determines the relation of order in time between the completion time of the access to the first device and the earliest time at which the access to the second device can be completed. If it is judged by the access completion time determination section that the access to the second device can be completed earlier than the completion time of the access to the first device, a bus access section accesses the second device in compliance with the second access request during the processing cycle of the access to the first device in compliance with the first access request.

### CROSS-REFERENCE TO RELATED APPLICATIONS

This application is based on, and claims priority to, Japanese Application No. 2002-073919, filed Mar. 18, 2002, in Japan, and which is incorporated herein by reference.

### BACKGROUND OF THE INVENTION

(1) Field of the Invention

The present invention relates to a microcomputer, a bus control circuit and a data access method for a microcomputer, and more particularly, to a microcomputer capable of accessing a plurality of devices through a shared bus, a bus control circuit built into such a microcomputer, and a data access method for such a microcomputer.

(2) Description of the Related Art

Currently, microcomputers are packaged in various electronic devices, and operations of such electronic devices are controlled by the microcomputers incorporated therein. Especially, in computer-controlled electronic devices such as digital cameras and printers, advanced data processing is carried out within the devices by the microcomputers. In the case of a digital camera, for example, the microcomputer performs, in addition to optical system control functions such as auto-focusing, a function of converting image data acquired by a CCD (Charge-Coupled Device) into a predetermined data format (e.g., JPEG (Joint Photographic Expert Group)).

With the sophistication of functions of computer-controlled electronic devices, microcomputers packaged in such electronic devices are required to have increased throughput. Generally, the throughput of a microcomputer is greatly affected by memory access speed. Specifically, if the memory access speed is relatively slow compared with the computing capacity of a CPU (Central Processing Unit), a long wait time is needed to read out instructions or data, with the result that the throughput of the microcomputer lowers.

The CPU accesses memory through the agency of a bus control circuit. When first and second access requests are received in succession, the bus control circuit first accesses memory in compliance with the first access request. Then, after completion of the access, the bus control circuit accesses memory in compliance with the second access request. In cases where first and second access requests occur simultaneously, the bus control circuit first performs an access in compliance with an access request with higher priority, in accordance with the order of priority set beforehand with respect to the access requests. After the access in compliance with the access request with higher priority is completed, the bus control circuit performs an access in compliance with the access request with lower priority. The order of priority of access requests may be either fixed or variable.

FIG. 15 is a timing chart illustrating an example of conventional memory access. The bus control circuit is connected to the CPU by an instruction bus and a data bus. Also, the bus control circuit is connected to semiconductor memories, such as ROM (Read Only Memory) and RAM (Random Access Memory), by a memory bus.

The instruction bus is a bus through which, in compliance with an access request from the CPU, instructions stored in memory are transferred to the CPU. Address, wait signal, data, etc. are transferred through the instruction bus. The wait signal is a signal which is active when set to high level (H-active).

The data bus is a bus through which, in compliance with an access request from the CPU, data stored in memory is transferred to the CPU. Address, wait signal, data, etc. are transferred through the data bus. The wait signal is a signal which is active when set to high level (H-active).

The memory bus is a bus through which, in compliance with an access request from the CPU, instructions or data stored in memory are read out or instructions or data are stored in memory. Address, ROM selection signal (ROMCSX), RAM selection signal (RAMCSX), read strobe signal (READX), data, etc. are transferred through the memory bus. The ROM selection signal (ROMCSX), the RAM selection signal (RAMCSX) and the read strobe signal (READX) are each a signal which is active when set to low level (L-active).

In the example shown in FIG. 15, it is assumed that an instruction fetch #1, a data read #2 and a data read #3 are issued in the order mentioned from the CPU as memory access requests. Instructions are stored in the ROM, while data is stored in the RAM. An architecture (structure) like this in which a program (instruction) memory (ROM) and a data memory (RAM) are provided independently of each other and an address bus and a data bus for one memory is separated from those for the other is called Harvard bus architecture.

Access requests issued from the CPU through the instruction bus and the data bus are each completed in a time corresponding to two cycles of a synchronizing signal at the shortest. If a request cannot be completed in two cycles, the bus control circuit outputs a wait signal. On receiving the wait signal, the CPU performs an access deferral process. In the example of FIG. 15, acquisition of instruction (instruction fetch) from the ROM requires a time corresponding to four cycles of the synchronizing signal, and data read from the RAM requires a time corresponding to two cycles of the synchronizing signal.

First, at the rise of cycle T1 of the synchronizing signal, an address for the instruction fetch #1 is output from the CPU to the instruction bus, whereupon the bus control circuit outputs the address for the instruction fetch #1 to the memory bus. At this time, the bus control circuit asserts (activates) the ROM selection signal (ROMCSX) and read strobe signal (READX) on the memory bus.

At the rise of cycle T2 of the synchronizing signal, the bus control circuit asserts the wait signal on the instruction bus, and the CPU outputs an address for the data read #2 to the data bus. At this point of time, however, the memory bus is used for the instruction fetch, and therefore, the bus control circuit asserts the wait signal on the data bus at the rise of cycle T3 of the synchronizing signal. Consequently, the access request for the data read #2 is deferred until completion of the instruction fetch.

Then, at the rise of cycle T4 of the synchronizing signal, the bus control circuit negates (deactivates) the wait signal on the instruction bus. Subsequently, within the time of cycle T4, the ROM outputs, onto the memory bus, a valid instruction VD#1 complying with the access request for the instruction fetch #1. The valid instruction VD#1 is output to the instruction bus by the bus control circuit.

At the rise of cycle T5 of the synchronizing signal, the transfer of the valid instruction VD#1 complying with the access request for the instruction fetch #1 is completed (the instruction fetch is completed). This completes the output of the address for the instruction fetch #1 to the instruction bus by the CPU. Also, the output of the address for the instruction fetch #1 to the memory bus by the bus control circuit is completed, and the bus control circuit outputs instead the address for the data read #2 to the memory bus. Simultaneously, the bus control circuit negates the ROM selection signal (ROMCSX) and asserts the RAM selection signal (RAMCSX). The read strobe signal (READX) is once negated by the bus control circuit simultaneously with completion of the transfer of the valid instruction VD#1 complying with the access request for the instruction fetch #1, but is asserted immediately thereafter for the access for the data read #2.

Then, at the rise of cycle T6 of the synchronizing signal, the bus control circuit negates the wait signal on the data bus. Subsequently, within the time of cycle T6, the RAM outputs, onto the memory bus, valid data VD#2 complying with the access request for the data read #2. The valid data VD#2 is output to the instruction bus by the bus control circuit.

At the rise of cycle T7 of the synchronizing signal, the transfer of the valid data VD#2 complying with the access request for the data read #2 is completed. This completes the output of the address for the data read #2 to the data bus by the CPU, and an address for the next access request, that is, the data read #3, is then output. Thus, the output of the address for the data read #2 to the memory bus by the bus control circuit is completed, and the bus control circuit outputs instead the address for the data read #3 to the memory bus. The RAM selection signal (RAMCSX) and the read strobe signal (READX) are kept asserted by the bus control circuit.

Within the time of cycle T8, the RAM outputs, onto the memory bus, valid data VD#3 complying with the access request for the data read #3, and the valid data VD#3 is output to the instruction bus by the bus control circuit.

At the rise of cycle T9 of the synchronizing signal, the transfer of the valid data VD#3 complying with the access request for the data read #3 is completed, whereupon the output of the address for the data read #3 to the data bus by the CPU is completed. Simultaneously, the output of the address for the data read #3 to the memory bus by the bus control circuit is completed. Also, the RAM selection signal (RAMCSX) and the read strobe signal (READX) are negated by the bus control circuit.

In the aforementioned manner, the instruction fetch from the ROM and the data read from the RAM are carried out in succession. In the illustrated example, the instruction fetch #1 requires four cycles while each of the data reads #2 and #3 requires two cycles to complete their respective access requests. Namely, a time equal to a total of eight cycles is required to complete access requests for one instruction fetch and two data reads.

Data access efficiency, however, lowers in the case where a plurality of memories having different data access speeds coexist as shown in FIG. 15.

Specifically, if an access request for a high-speed memory (e.g., RAM) is output during the access to a low-speed memory (e.g., ROM), the access to the high-speed memory is deferred until completion of the access to the low-speed memory. In the example of FIG. 15, the access request for the data read #2 is output during the access to the ROM for the instruction fetch, and therefore, the access is deferred for three cycles (cycles T3-T5). As a result, even though the access to the RAM can be completed in two cycles, a time equal to five cycles is required for the data read #2.

Cross bus technique, for example, is known as a method for lessening such access wait and thereby enhancing the access efficiency. The cross bus technique is a memory access technique which is used in cases where simultaneous occurrence of access requests is expected and in which memories are provided with respective memory buses. With this technique, it is possible to simultaneously access a plurality of memories with different data access speeds, but an increased number of buses makes the hardware circuitry complicated and increases the cost of the microcomputer.

Also, in the case of a system having a plurality of CPUs, exclusive memory, besides shared memory, may be connected to each CPU to prevent the contention for accesses. However, also in this case, the hardware circuitry becomes complicated and the cost of the microcomputer increases, as with the cross bus technique.

Accordingly, there has been a demand for techniques that improve the memory access efficiency as well as the throughput of a microcomputer without the need to increase the number of memory buses.

### SUMMARY OF THE INVENTION

The present invention was created in view of the above circumstances, and an object thereof is to provide a microcomputer capable of efficiently accessing a plurality of devices with different access speeds through a shared bus, a bus control circuit and a data access method for such a microcomputer.

To achieve the object, there is provided a microcomputer capable of accessing a plurality of devices through a shared bus. The microcomputer comprises an access completion time determination section for determining a relation of order in time between a time of completion of access to a first device and an earliest time at which access to a second device can be completed, based on required access times for the first and second devices when, during access to the first device in compliance with a first access request, a second access request for the second device is issued from a CPU, and a bus access section for performing the access to the second device in compliance with the second access request during a processing cycle of the access to the first device in compliance with the first access request if it is judged by the access completion time determination section that the access to the second device can be completed earlier than the completion time of the access to the first device.

Also, to achieve the above object, there is provided a bus control circuit for accessing a plurality of devices through a shared bus in response to requests from a CPU. The bus control circuit comprises an access completion time determination section for determining a relation of order in time between a time of completion of access to a first device and an earliest time at which access to a second device can be completed, based on required access times for the first and second devices when, during access to the first device in compliance with a first access request, a second access request for the second device is issued from the CPU, and a bus access section for performing the access to the second device in compliance with the second access request during a processing cycle of the access to the first device in compliance with the first access request if it is judged by the access completion time determination section that the access to the second device can be completed earlier than the completion time of the access to the first device.

Further, to achieve the above object, there is provided a data access method for a microcomputer capable of accessing a plurality of devices through a shared bus. The data access method comprises determining a relation of order in time between a time of completion of access to a first device and an earliest time at which access to a second device can be completed, based on required access times for the first and second devices when, during access to the first device in compliance with a first access request, a second access request for the second device is issued from a CPU, and performing the access to the second device in compliance with the second access request during a processing cycle of the access to the first device in compliance with the first access request if it is judged that the access to the second device can be completed earlier than the completion time of the access to the first device.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a conceptual diagram illustrating the present invention applied to various embodiments;

FIG. 2 is a flowchart illustrating a process executed when, during an access in compliance with a first access request, a second access request is issued;

FIG. 3 is a flowchart illustrating a process executed when first and second access requests are issued simultaneously;

FIG. 4 is a block diagram illustrating an exemplary hardware configuration of an electronic device according to a first embodiment of the present invention;

FIG. 5 is a block diagram illustrating an internal configuration of a bus control circuit;

FIG. 6 is a diagram illustrating an exemplary data structure of a wait setting register group;

FIG. 7 is a diagram illustrating an exemplary data structure of memory area information held in an area determination section;

FIG. 8 is a diagram illustrating an exemplary data structure of access completion time information held in a completion time determination section;

FIG. 9 is a flowchart illustrating a process executed when, during an access, another access request is output;

FIG. 10 is a timing chart illustrating a case where, during an access, another access request is output;

FIG. 11 is a flowchart illustrating a process executed when a plurality of access requests are output simultaneously;

FIG. 12 is a timing chart illustrating a case where a plurality of access requests are output simultaneously;

FIG. 13 is a diagram illustrating an exemplary hardware configuration of an electronic device according to a second embodiment;

FIG. 14 is a diagram illustrating an exemplary hardware configuration of an electronic device according to a third embodiment; and

FIG. 15 is a timing chart illustrating an example of conventional memory access.

### DESCRIPTION OF THE PREFERRED EMBODIMENTS

Embodiments of the present invention will be hereinafter described with reference to the drawings.

The present invention applied to various embodiments will be outlined first, and then specific embodiments will be described.

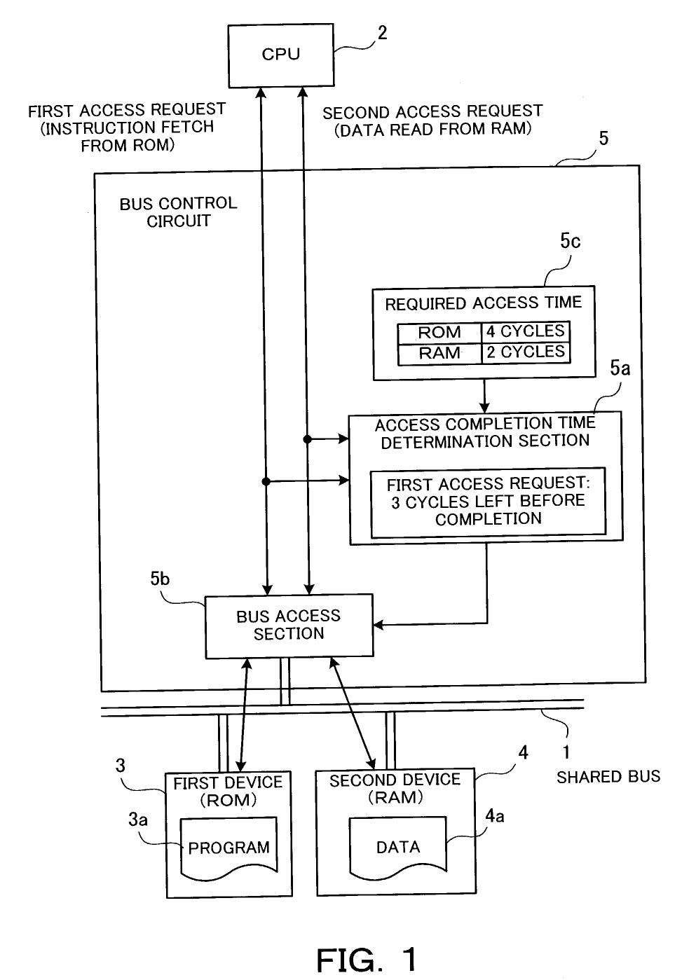

FIG. 1 is a conceptual diagram illustrating the present invention applied to various embodiments. A computer-controlled electronic device to which the present invention is applied comprises, for example, a shared bus 1, a CPU 2, a first device 3, a second device 4, and a bus control circuit 5. The CPU 2 and the bus control circuit 5 constitute a microcomputer.

The shared bus 1 is a bus to which a plurality of devices to be accessed from the CPU 2 are connected. In the example shown in FIG. 1, the first and second devices 3 and 4 are connected to the shared bus 1.

The CPU 2 controls the entire computer-controlled electronic device in accordance with instructions described in programs. Data necessary for the process in accordance with instructions is acquired from the first or second device 3 or 4 via the bus control circuit 5.

The first device 3 is a device which can be accessed from the CPU 2 and comprises, for example, a ROM. In the example of FIG. 1, the first device 3 stores a program 3a, which is a sequence of instruction codes to be executed by the CPU 2.

The second device 4 also can be accessed from the CPU 2. The second device 4 is a device which can be accessed at a higher speed than the first device 3 and comprises, for example, a RAM. In the example of FIG. 1, the second device 4 stores data 4a.

The bus control circuit 5 accesses the first or second device 3 or 4 through the shared bus 1 in response to an access request from the CPU 2. The bus control circuit 5 includes an access completion time determination section 5a and a bus access section 5b, and holds in advance required access times 5c for the respective devices (first and second devices 3 and 4). In the example shown in FIG. 1, access to the first device 3 requires a time corresponding to four cycles, while access to the second device 4 requires a time corresponding to two cycles. The cycle mentioned herein denotes an interval of generation of a synchronizing signal on the shared bus 1.

If, during an access to the first device 3 in compliance with a first access request, a second access request for the second device 4 is issued from the CPU 2, the access completion time determination section 5a determines a relation of order in time between the time of completion of the access to the first device 3 and the earliest time at which the access to the second device 4 can be completed, based on the required access times 5c for the first and second devices 3 and 4. Also, if a plurality of access requests for the first and second devices 3 and 4 are issued simultaneously (within one cycle) from the CPU 2, the access completion time determination section 5a determines the relation of order in time between the earliest time at which the access to the first device 3 to be accessed in advance can be completed and the earliest time at which the access to the second device 4 to be accessed next can be completed, based on the required access times 5c for the first and second devices 3 and 4. The order of priority of accesses, which is applied when a plurality of accesses occur simultaneously, is set such that a device requiring a longer access time 5c is given higher priority, for example.

If it is judged by the access completion time determination section 5a that the access to the second device 4 can be completed earlier than the completion time of the access to the first device 3, the bus access section 5b performs the access to the second device 4 in compliance with the second access request during the processing cycle of the access to the first device 3 in compliance with the first access request.

According to the computer-controlled electronic device described above, the first and second devices 3 and 4 can be efficiently accessed through the shared bus 1.

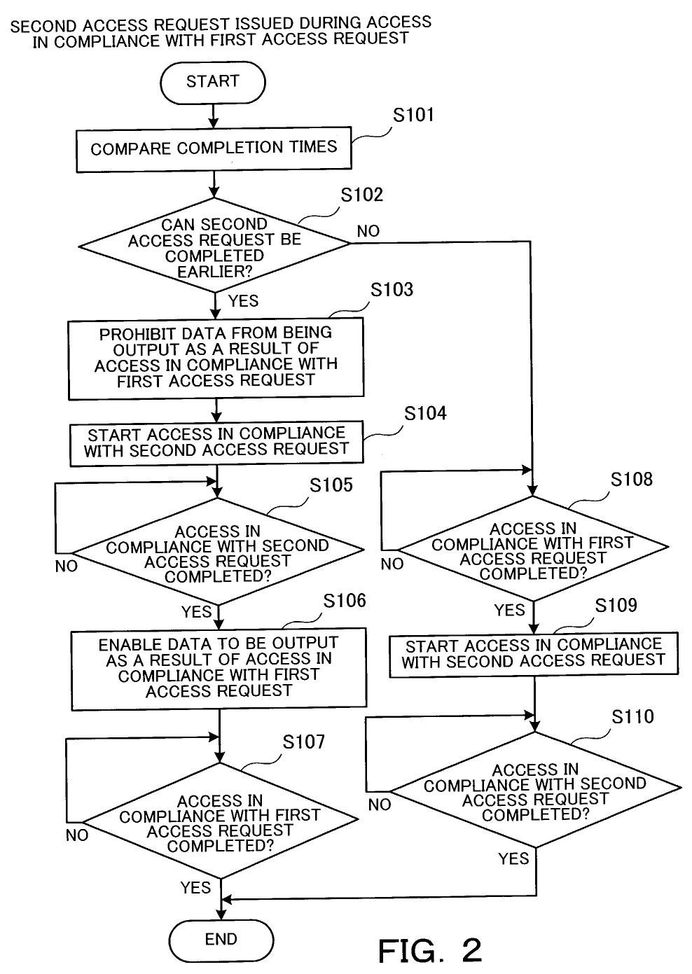

FIG. 2 is a flowchart illustrating a process executed when, during an access in compliance with a first access request, a second access request is issued.

When the second access request is output from the CPU 2, the access completion time determination section 5a compares the time of completion of the access in compliance with the first access request with the earliest time at which the access in compliance with the second access request can be completed (Step S101). The access completion time determination section 5a transfers the comparison result to the bus access section 5b.

If the second access request can be completed earlier (YES in Step S102), the bus access section 5b prohibits data from being output as a result of the access in compliance with the first access request (Step S103). For example, the bus access section 5b disables (negates) an output enabling signal (read strobe signal) for the device being accessed, such as memory. Subsequently, the bus access section 5b starts the access in compliance with the second access request (Step S104).

While the access in compliance with the second access request is not completed yet (NO in Step S105), the process does not proceed. If the access in compliance with the second access request is completed (YES in Step S105), the bus access section 5b enables data to be output as a result of the access in compliance with the first access request (Step S106). For example, the bus access section 5b enables (asserts) the output enabling signal (read strobe signal) for the device being accessed, such as memory.

While the access in compliance with the first access request is not completed yet (NO in Step S107), the process does not proceed. If the access in compliance with the first access request is completed (YES in Step S107), then the bus access process is ended.

On the other hand, if the second access request cannot be completed earlier (NO in Step S102), the access in compliance with the first access request is continued, and while this access is not completed yet (NO in Step S108), the process does not proceed. If the access in compliance with the first access request is completed (YES in Step S108), the bus access section 5b starts the access in compliance with the second access request (Step S109).

While the access in compliance with the second access request is not completed yet (NO in Step S110), the process does not proceed. If the access in compliance with the second access request is completed (YES in Step S110), then the bus access process is ended.

In this manner, access requests for different devices that are issued in succession can be processed at the same time (in a manner such that time periods needed for the accesses overlap with each other), whereby the bus access efficiency can be enhanced.

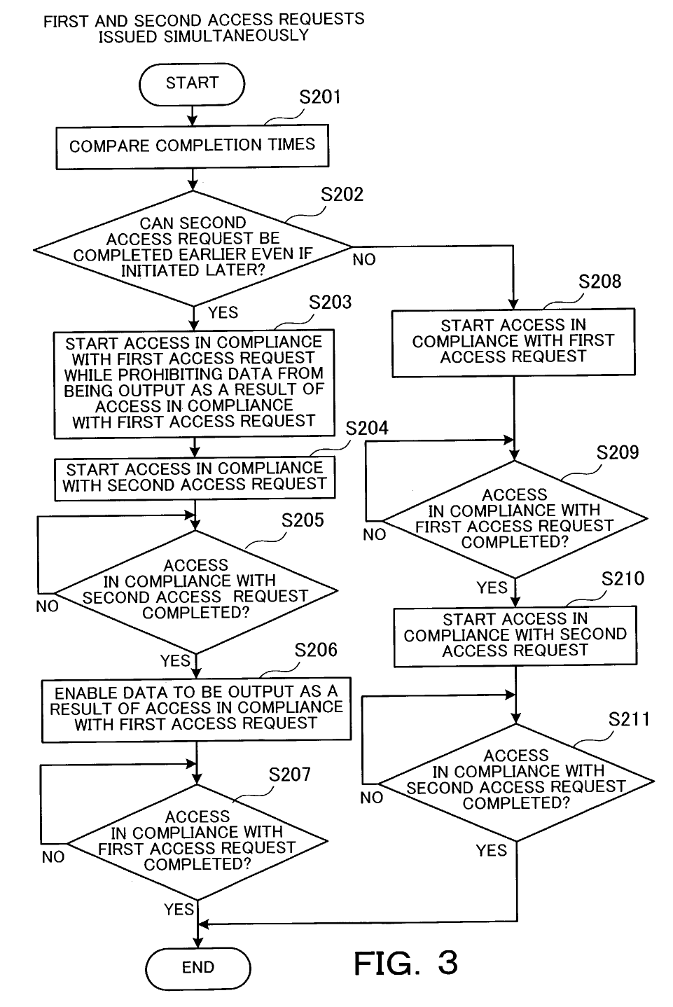

FIG. 3 is a flowchart illustrating a process executed when first and second access requests are issued simultaneously. If the first and second access requests are output simultaneously from the CPU 2, the access completion time determination section 5a decides that the access to a device requiring a longer access time (device with a longer required access time) should be performed first. Then, the access completion time determination section 5a compares the earliest time at which the access in compliance with the first access request to be performed first can be completed with the earliest time at which the access in compliance with the second access request can be completed when the access is started one cycle later (Step S201). The access completion time determination section 5a transfers the comparison result to the bus access section 5b.

Where the second access request can be completed earlier (YES in Step S202), the bus access section 5b starts the access in compliance with the first access request while at the same time prohibits data from being output as a result of the access in compliance with the first access request (Step S203). Subsequently, the bus access section 5b starts the access in compliance with the second access request (Step S204).

While the access in compliance with the second access request is not completed yet (NO in Step S205), the process does not proceed. If the access in compliance with the second access request is completed (YES in Step S205), the bus access section 5b enables data to be output as a result of the access in compliance with the first access request (Step S206).

While the access in compliance with the first access request is not completed yet (NO in Step S207), the process does not proceed. If the access in compliance with the first access request is completed (YES in Step S207), then the bus access process is ended.

On the other hand, where the second access request cannot be completed earlier (NO in Step S202), the bus access section 5b starts the access in compliance with the first access request (Step S208) while at the same time enables data to be output as a result of the access in compliance with the first access request. While the access in compliance with the first access request is not completed yet (NO in Step S209), the process does not proceed. If the access in compliance with the first access request is completed (YES in Step S209), the bus access section 5b starts the access in compliance with the second access request (Step S210).

While the access in compliance with the second access request is not completed yet (NO in Step S211), the process does not proceed. If the access in compliance with the second access request is completed (YES in Step S211), then the bus access process is ended.

In this manner, accesses to different devices that are requested simultaneously can be processed at the same time (in a manner such that time periods needed for the accesses overlap with each other), whereby the bus access efficiency can be enhanced.

Specific embodiments of the present invention will be now described.

[First Embodiment]

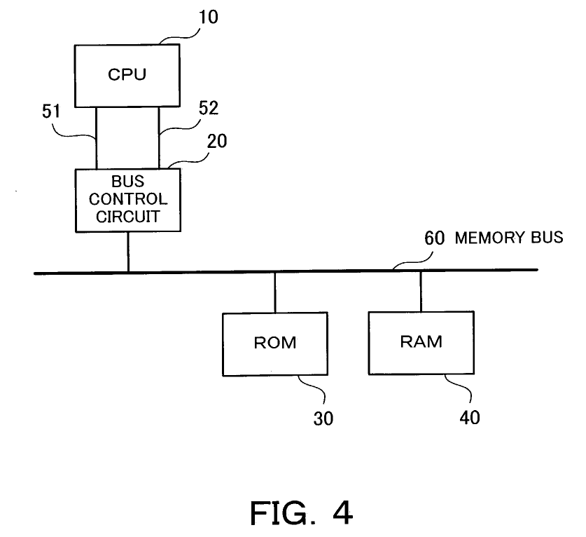

FIG. 4 is a block diagram illustrating an exemplary hardware configuration of an electronic device according to a first embodiment of the present invention. The electronic device according to the first embodiment of the present invention includes a CPU 10, a bus control circuit 20, a ROM 30, and a RAM 40. In the first embodiment, Harvard bus architecture is adopted. Specifically, the CPU 10 is connected to the bus control circuit 20 through an instruction bus 51 and a data bus 52. The bus control circuit 20, the ROM 30 and the RAM 40 are interconnected by a memory bus 60.

The CPU 10 controls the operation of the entire electronic device. Specifically, the CPU 10 accesses the ROM 30 and the RAM 40 via the bus control circuit 20 and, using data stored in the ROM 30 or the RAM 40, performs data processing in accordance with instructions stored in the ROM 30. When carrying out an instruction fetch (acquisition of an instruction code), the CPU 10 outputs an access request to the bus control circuit 20 through the instruction bus 51. Also, when accessing data, the CPU 10 outputs an access request to the bus control circuit 20 through the data bus 52. The CPU 10 fetches instructions mainly from the ROM 30, and accesses mainly the RAM 40 for data access.

In response to an access request from the CPU 10, the bus control circuit 20 acquires an instruction code or data from the ROM 30 or the RAM 40. Then, the bus control circuit 20 transfers the acquired instruction code or data to the CPU 10. The instruction code is transferred to the CPU 10 through the instruction bus 51, while the data is transferred to the CPU 10 through the data bus 52.

When an access request for the ROM 30 or the RAM 40 is output from the CPU 10, the bus control circuit 20 makes a determination as to contention between instruction fetch and data access. If, as a result of the determination as to contention, it is judged that a plurality of access requests have been output simultaneously from the CPU 10, the bus control circuit 20 determines timings for starting accesses in compliance with the respective access requests, based on the completion times of the accesses in compliance with the respective access requests. Then, in accordance with the determined timings, the bus control circuit 20 accesses the ROM 30 and the RAM 40.

The ROM 30 is a semiconductor memory with a relatively low access speed (slower than the RAM 40). The ROM 30 mainly stores programs describing processes to be executed by the CPU 10, and such programs are described using instruction codes executable by the CPU 10. The ROM 30 is connected to an address signal line, selection signal line for the ROM 30, read strobe signal line, data signal line, etc. of the memory bus 60. When the selection signal for the ROM 30 and the read strobe signal are asserted, the ROM 30 reads out an instruction code (or data) at the address specified by the address signal line and outputs the same onto the data signal line.

Also, the ROM 30 has a built-in circuit for latching an address (temporarily holding data) output to the address signal line of the memory bus 60. Specifically, when the selection signal for the ROM 30 is activated, the ROM 30 latches the address then output to the address signal line and accesses data at this address. Even if the address output to the address signal line of the memory bus 60 changes before completion of the access, the ROM 30 can continue the data access based on the latched address.

The RAM 40 is a semiconductor memory with a relatively high access speed (faster than the ROM 30). The RAM 40 is used by the CPU 10 as a work area when performing processes and stores various data. The RAM 40 is connected to an address signal line, selection signal line for the RAM 40, read strobe signal line, data signal line, etc. of the memory bus 60. When the selection signal for the RAM 40 and the read strobe signal are asserted, the RAM 40 reads out data at the address specified by the address signal line and outputs the same onto the data signal line.

The instruction bus 51 is a bus through which the CPU 10 fetches instruction codes, and has an address signal line, a wait signal line, a data signal line, etc. connecting between the CPU 10 and the bus control circuit 20. The address signal line and the data signal line are each constituted by a plurality of signal lines.

The data bus 52 is a bus through which the CPU 10 fetches data and outputs results of operations performed thereby, and has an address signal line, a wait signal line, a data signal line, etc. connecting between the CPU 10 and the bus control circuit 20. The address signal line and the data signal line are each constituted by a plurality of signal lines.

The memory bus 60 is a shared bus through which instruction codes or data is transferred between the bus control circuit 20 and the ROM 30 or the RAM 40. The memory bus 60 has an address signal line, a selection signal line for the ROM 30, a read strobe signal line for the ROM, a data signal line, etc. connecting between the bus control circuit 20 and the ROM 30.

The internal configuration of the bus control circuit 20 will be now described in detail.

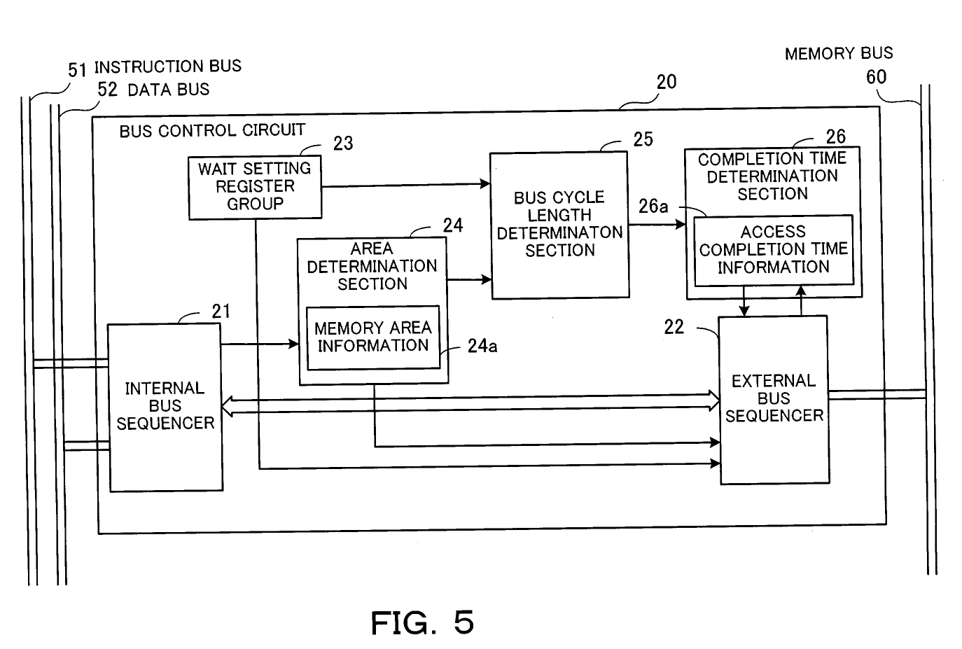

FIG. 5 is a block diagram illustrating the internal configuration of the bus control circuit. The bus control circuit 20 includes an internal bus sequencer 21, an external bus sequencer 22, a wait setting register group 23, an area determination section 24, a bus cycle length determination section 25 and a completion time determination section 26.

Among the elements constituting the bus control circuit 20, those which need to exchange information are connected to each other. Specifically, the internal bus sequencer 21 is connected to the instruction bus 51 and the data bus 52. The external bus sequencer 22 is connected to the memory bus 60. The internal and external bus sequencers 21 and 22 are bus-connected inside the bus control circuit 20. The wait setting register group 23 is connected to the external bus sequencer 22 and the bus cycle length determination section 25. The area determination section 24 is connected to the internal and external bus sequencers 21 and 22 and the bus cycle length determination section 25. The bus cycle length determination section 25 is connected to the completion time determination section 26, in addition to the connections already mentioned. The completion time determination section 26 is also connected to the external bus sequencer 22, besides the element 25.

In FIG. 5, the connections between the various elements in the bus control circuit 20 are indicated by arrows, and the directions of the arrows indicate transfer directions of information.

The internal bus sequencer 21 transmits and receives instruction codes or data to and from the CPU 10 through the instruction bus 51 or the data bus 52. For example, on receiving an access request for the ROM 30 or the RAM 40 from the CPU 10, the internal bus sequencer 21 transfers the access request to the external bus sequencer 22. The access request includes an address to be accessed. Also, when an access request is received from the CPU 10, the internal bus sequencer 21 transfers the address to be accessed to the area determination section 24.

Further, on receiving an instruction code from the external bus sequencer 22 as a result of an instruction fetch, the internal bus sequencer 21 transfers the instruction code to the CPU 10 through the instruction bus 51. Also, when data is received from the external bus sequencer 22 as a result of a data access, the internal bus sequencer 21 transfers the data to the CPU 10 through the data bus 52.

The external bus sequencer 22 transmits and receives instruction codes or data to and from the ROM 30 or the RAM 40 through the memory bus 60. For example, on receiving an access request from the internal bus sequencer 21, the external bus sequencer 22 determines based on area information from the area determination section 24 whether the ROM 30 or the RAM 40 is to be accessed. Then, in compliance with the access request, the external bus sequencer 22 accesses the memory which is judged to be a target of access.

Also, if, during an access to one memory through the memory bus 60, an access request for the other memory is received, the external bus sequencer 22 acquires the result of determination as to completion times from the completion time determination section 26. If it is judged that the access request output later can be completed earlier, the external bus sequencer 22 performs a process in compliance with the later access request, without waiting for the completion of the ongoing access.

Further, on receiving an instruction code or data through the memory bus 60, the external bus sequencer 22 transfers the instruction code or data to the internal bus sequencer 21. Also, the external bus sequencer 22 notifies as required the completion time determination section 26 of information about the status of memory access in compliance with the access request.

The wait setting register group 23 is a set of wait setting registers associated with the respective memories. Each wait setting register is set in advance with a time period for which the wait signal should be generated when the corresponding memory is accessed. The wait signal generation period is set as the number of cycles of the synchronizing signal on the bus, for example. The contents of the wait setting registers can be modified through input operation by the user, etc.

The area determination section 24 identifies, based on the address included in an access request, a memory which is to be accessed in compliance with the access request. Specifically, the area determination section 24 holds memory area information 24a and looks up this memory area information 24a to identify a memory. The memory area information 24a has defined therein the ranges of memory spaces of the ROM 30 and RAM 40. The area determination section 24 determines in which memory space of either memory the address specified by an access request is included, to thereby identify a memory to be accessed. Then, the area determination section 24 transfers the determination result to the external bus sequencer 22 and the bus cycle length determination section 25.

The bus cycle length determination section 25 determines the bus cycle length for each access request. The bus cycle length represents a time period required for the access in compliance with an access request, expressed by the number of cycles of the synchronizing signal on the bus. Specifically, the bus cycle length determination section 25 receives, from the area determination section 24, information specifying a memory to be accessed, and acquires the content of the wait setting register associated with the specified memory. Subsequently, based on the wait signal generation period indicated by the wait setting register, the bus cycle length determination section 25 determines a bus cycle length. More specifically, the bus cycle length determination section 25 sets, as the bus cycle length, the sum of a read time necessary for the CPU 10 to read an instruction code or data through the instruction bus 51 or the data bus 52 and the wait signal generation period. For example, if the read time necessary for the CPU 10 to read an instruction code or data is equal to two cycles of the synchronizing signal on the bus and the wait signal generation period is equal to two cycles, the bus cycle length is set to four cycles. The bus cycle length determination section 25 notifies the completion time determination section 26 of the determination result.

The completion time determination section 26 determines completion times of accesses which comply with a plurality of access requests and which overlap in time with each other. Specifically, the completion time determination section 26 receives the result of determination as to the bus cycle length for an access request from the bus cycle length determination section 25, and determines whether or not memory access is being performed by the external bus sequencer 22.

If no access is under execution, the completion time determination section 26 holds the value of the bus cycle length as access completion time information 26a. The value held as the access completion time information 26a is counted down by the completion time determination section 26 with lapse of every cycle of the synchronizing signal on the bus. Thus, the access completion time information 26a represents the number of clock cycles needed up to completion of the access currently performed.

On the other hand, if an access is being performed, the completion time determination section 26 compares the bus cycle length newly received from the bus cycle length determination section 25 with the access completion time (number of clock cycles indicating a period from the current time up to completion of the access) set as the access completion time information 26a. Then, the completion time determination section 26 determines which of the currently performed access and the access in compliance with the newly received access request can be completed earlier. The completion time determination section 26 transfers the determination result to the external bus sequencer 22.

Exemplary data structures of various information held in the bus control circuit 20 will be now described.

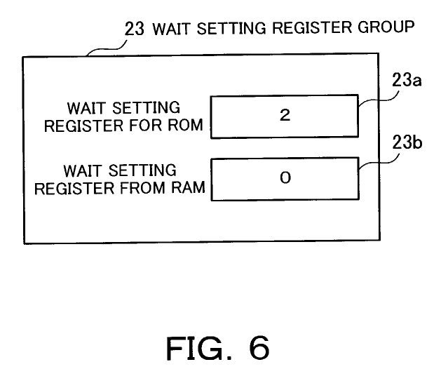

FIG. 6 illustrates an exemplary data structure of the wait setting register group. The wait setting register group 23 is constituted by a plurality of wait setting registers 23a and 23b. Since, in the first embodiment, the ROM 30 and the RAM 40 are connected to the memory bus 60, the wait setting registers 23a and 23b are associated with the ROM 30 and the RAM 40, respectively.

In the example shown in FIG. 6, “2” is set in the wait setting register 23a for the ROM 30, and “0” is set in the wait setting register 23b for the RAM 40. Namely, when the ROM 30 is accessed, the wait signal is output to the CPU 10 for two cycles at the shortest. When the RAM 40 is accessed, no wait signal is output unless another access is being performed. That is, an access to the RAM 40 can be completed in a time period equal to that necessary for the CPU 10 to access through the instruction bus 51 or the data bus 52.

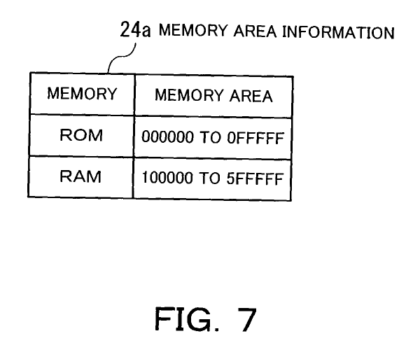

FIG. 7 illustrates an exemplary data structure of the memory area information held in the area determination section. As the memory area information 24a, memory spaces (memory areas) set for the individual memories in the system are defined in association with the respective memories connected to the memory bus 60. Specifically, ranges of addresses for accessing the respective memories are set as the memory area information 24a. In the example shown in FIG. 7, the range of addresses “000000 to 0FFFFF” is set as the memory area of the ROM 30, and the range of addresses “100000 to 5FFFFF” is set as the memory area of the RAM 40.

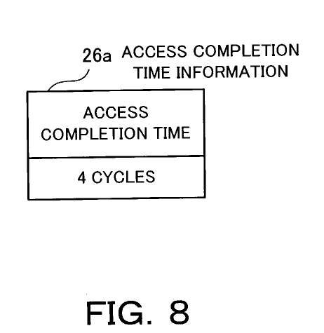

FIG. 8 illustrates an exemplary data structure of the access completion time information held in the completion time determination section. As shown in FIG. 8, a time period needed up to completion of the currently performed access is set as the access completion time information 26a. In the example of FIG. 8, a period corresponding to four cycles of the synchronizing signal is set as the completion time. The value set as the access completion time information 26a is counted down each time the synchronizing signal is output, and at the point of time when the access completion time information 26a becomes “0,” the countdown is ended. When the access completion time information 26a is “0,” it means that there is no access currently performed.

By using the bus control circuit 20 configured as described above, it is possible to efficiently process a plurality of time-overlapped access requests for a plurality of memories. Access requests can overlap in time in cases where during an access in compliance with one access request, another access request is output, or where a plurality of access requests are output simultaneously. In the following, with reference to the individual cases where the overlapping of access requests occurs, the process performed by the bus control circuit 20 will be described in detail.

[During an access, another access request is output.]

According to the first embodiment, in cases where a newly received access request can be completed earlier than the currently performed access, a process in compliance with the later received access request is allowed to interrupt before completion of the currently performed access. A procedure for allowing the interrupt of a process in compliance with a later received access request will be described.

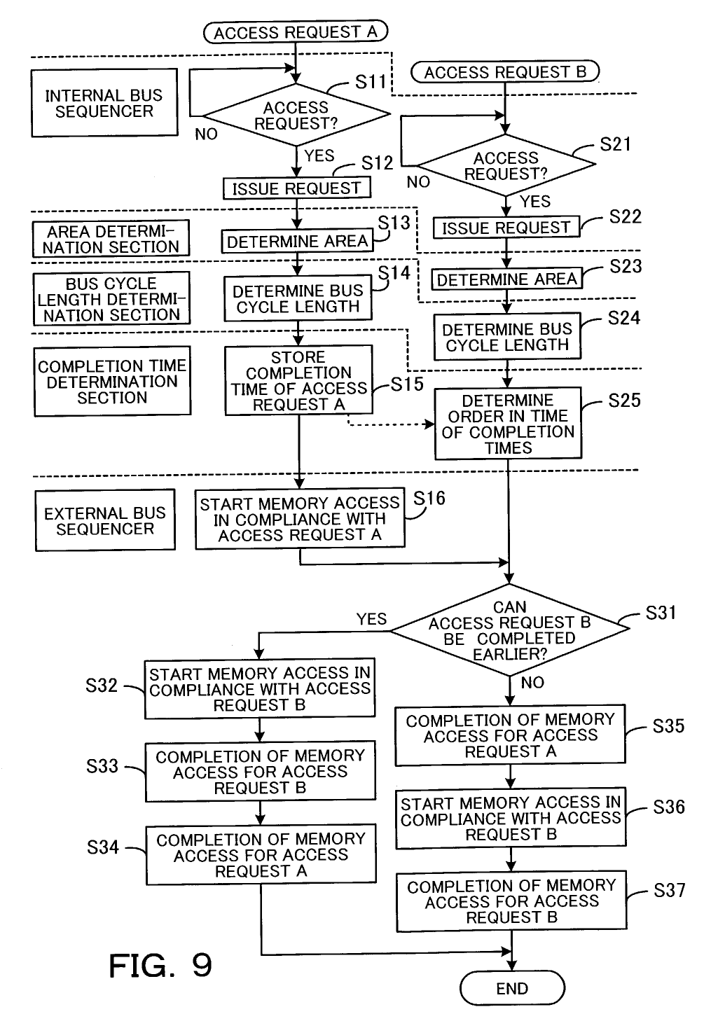

FIG. 9 is a flowchart illustrating a process executed when, during an access, another access request is output. The process shown in FIG. 9 will be described in order of step number. In the following, an access request output earlier from the CPU 10 is referred to as “access request A” and an access request output later from the CPU 10 is referred to as “access request B.”

[Step S11] The internal bus sequencer 21 constantly determines whether or not an access request has occurred. While no access request is received, Step S11 is repeatedly executed. If an access request A is input through the instruction bus 51 or the data bus 52, the internal bus sequencer 21 judges that an access request has occurred, whereupon the process proceeds to Step S12.

[Step S12] The internal bus sequencer 21 issues the access request A to the external bus sequencer 22. Simultaneously, the internal bus sequencer 21 notifies the area determination section 24 of the address specified by the access request.

[Step S13] Based on the address transferred from the internal bus sequencer 21, the area determination section 24 determines which memory area should be accessed in compliance with the access request A. Then, the area determination section 24 notifies the external bus sequencer 22 and the bus cycle length determination section 25 of the determination result.

[Step S14] The bus cycle length determination section 25 acquires, from the wait setting register group 23, the value of the wait setting register associated with the memory which is to be accessed in compliance with the access request A. Then, the bus cycle length determination section 25 determines the time period required for the access in compliance with the access request A. The determination result is expressed as the number of cycles of the synchronizing signal on the bus. The bus cycle length determination section 25 notifies the completion time determination section 26 of the determination result.

[Step S15] The completion time determination section 26 stores, as the access completion time information 26a, the time period needed up to completion of the process in compliance with the access request A. Each time the synchronizing signal is output to the bus thereafter, the completion time determination section 26 counts down the value (number of cycles) stored as the access completion time information 26a.

[Step S16] The external bus sequencer 22 starts memory access in compliance with the access request A. Subsequently, an access request B is output, so that the process in compliance with the access request A is executed thereafter dependently on the interrelation with the process in compliance with the access request B. The process in compliance with the access request A is continued to Step S31.

The above is the process executed when the access request A is output from the CPU 10. The following describes the process executed when the access request B is output during the process in compliance with the access request A.

[Step S21] The internal bus sequencer 21 constantly determines whether or not an access request has occurred. While no access request is received, Step S21 is repeatedly executed. When the access request B is input through the instruction bus 51 or the data bus 52, the internal bus sequencer 21 judges that an access request has occurred, whereupon the process proceeds to Step S22.

[Step S22] The internal bus sequencer 21 issues the access request B to the external bus sequencer 22. Simultaneously, the internal bus sequencer 21 notifies the area determination section 24 of the address specified by the access request.

[Step S23] Based on the address transferred from the internal bus sequencer 21, the area determination section 24 determines which memory area should be accessed in compliance with the access request B. Then, the area determination section 24 notifies the external bus sequencer 22 and the bus cycle length determination section 25 of the determination result.

[Step S24] The bus cycle length determination section 25 acquires, from the wait setting register group 23, the value of the wait setting register associated with the memory which is to be accessed in compliance with the access request B. Then, the bus cycle length determination section 25 determines the time period required for the access in compliance with the access request B. The determination result is expressed as the number of cycles of the synchronizing signal on the bus. The bus cycle length determination section 25 notifies the completion time determination section 26 of the determination result.

[Step S25] The completion time determination section 26 recognizes that there is an access currently performed, since the access completion time information 26a is set therein. Accordingly, the completion time determination section 26 compares the bus cycle length for the access request B, received from the bus cycle length determination section 25, with the access completion time information 26a. Based on the result of comparison, the completion time determination section 26 determines the relation of order in time between the completion times of the access requests A and B. The completion time determination section 26 then transfers the result of determination to the external bus sequencer 22.

The determination result can be one of the following three: “The process in compliance with the access request A can be completed earlier”; “the process in compliance with the access request B can be completed earlier”; and “the processes in compliance with the access requests A and B can be completed at the same time.” In the first embodiment, whether the access request B can be completed earlier or not alone is determined.

[Step S31] The external bus sequencer 22 determines whether or not the received determination result shows that the access request B can be completed earlier. If it is judged that the access request B can be completed earlier, the process proceeds to Step S32; if it is judged that the access request B cannot be completed earlier, the process proceeds to Step S35.

[Step S32] The external bus sequencer 22 starts memory access in compliance with the access request B.

[Step S33] The external bus sequencer 22 completes the memory access in compliance with the access request B, whereupon the instruction code or data is transferred from the external bus sequencer 22 to the internal bus sequencer 21. Subsequently, the instruction code or data is transferred from the internal bus sequencer 21 to the CPU through the instruction bus 51 or the data bus 52.

[Step S34] The external bus sequencer 22 completes the memory access in compliance with the access request A. The acquired instruction code or data is transferred to the CPU 10 in the same manner as explained above in Step S33.

[Step S35] The external bus sequencer 22 completes the memory access in compliance with the access request A. The acquired instruction code or data is transferred to the CPU 10 in the same manner as explained in Step S33.

[Step S36] The external bus sequencer 22 starts memory access in compliance with the access request B.

[Step S37] The external bus sequencer 22 completes the memory access in compliance with the access request B. The acquired instruction code or data is transferred to the CPU 10 in the same manner as explained in Step S33, whereupon the process is ended.

In this manner, if the access request B is output during the access in compliance with the access request A and if the access request B can be completed earlier, the process in compliance with the access request B can be performed while interrupting the ongoing access.

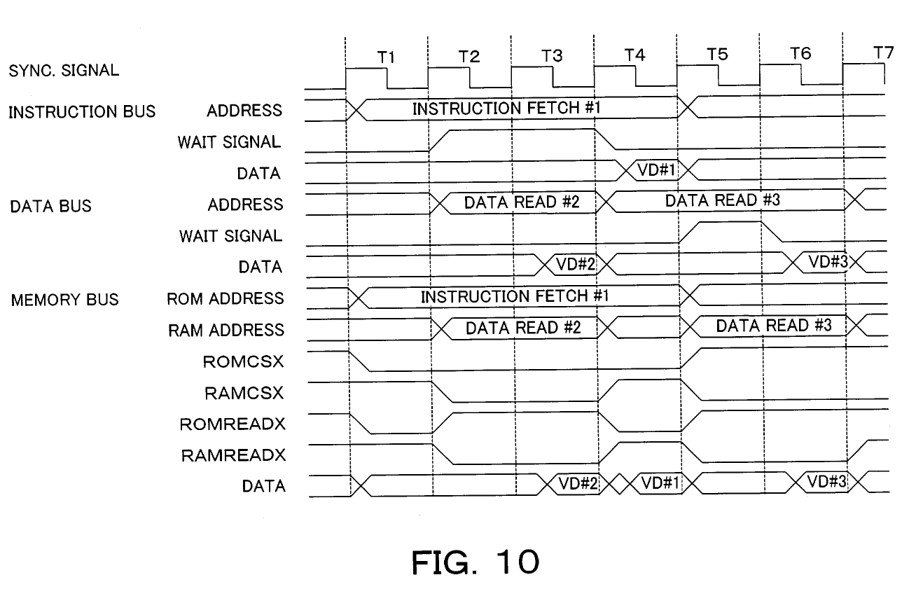

FIG. 10 is a timing chart illustrating the case where, during an access, another access request is output.

Through the instruction bus 51, address, wait signal, data, etc. are transferred. The wait signal is a signal which is active when set to high level (H-active). Similarly, address, wait signal, data, etc. are transferred through the data bus 52. The wait signal is a signal which is active when set to high level (H-active). Through the memory bus 60, ROM address, RAM address, ROM selection signal (ROMCSX), RAM selection signal (RAMCSX), ROM read strobe signal (ROMREADX), RAM read strobe signal (RAMREADX), data, etc. are transferred. The ROM selection signal (ROMCSX), the RAM selection signal (RAMCSX), the ROM read strobe signal (ROMREADX) and the RAM read strobe signal (RAMREADX) are each a signal which is active when set to low level (L-active).

In the example shown in FIG. 10, it is assumed that an instruction fetch #1, a data read #2 and a data read #3 are issued from the CPU 10 in the order mentioned, as access requests for the memories (ROM 30 and RAM 40). Access requests output from the CPU 10 through the instruction bus 51 and the data bus 52 are each completed in a time corresponding to two cycles of the synchronizing signal at the shortest. If a request cannot be completed in two cycles, the bus control circuit 20 outputs a wait signal. On receiving the wait signal, the CPU 10 performs an access deferral process. In the example of FIG. 10, acquisition of instruction (instruction fetch) from the ROM 30 requires a time corresponding to four cycles of the synchronizing signal, and data read from the RAM 40 requires a time corresponding to two cycles of the synchronizing signal.

First, at the rise of cycle T1 of the synchronizing signal, an address for the instruction fetch #1 (access request for the ROM 30) is output from the CPU 10 to the instruction bus 51, whereupon the bus control circuit 20 outputs the address (ROM address) for the instruction fetch #1 to the memory bus 60. At this time, the bus control circuit 20 asserts the ROM selection signal (ROMCSX) and ROM read strobe signal (ROMREADX) on the memory bus 60.

At the rise of cycle T2 of the synchronizing signal, the bus control circuit 20 asserts the wait signal on the instruction bus, and the CPU 10 outputs an address for the data read #2 (access request for the RAM 40) to the data bus 52.

At this point of time, however, the memory bus 60 is used for the instruction fetch, that is, the access in compliance with the access request for the instruction fetch #1 is under execution. Accordingly, the access completion time of the instruction fetch #1 is compared with the access completion time of the data read #2.

The instruction fetch #1 requires four clock cycles and thus a time period corresponding to three clock cycles is still needed. Namely, the access completion time of the instruction fetch #1 is coincident with the rise of cycle T5 of the synchronizing signal. On the other hand, the data read #2 requires two clock cycles, that is, the completion time of the data read is coincident with the rise of cycle T4 of the synchronizing signal.

Thus, as a result of the comparison of the access completion times by the completion time determination section 26, it is judged that the data read #2 can be completed earlier. Accordingly, at the rise of cycle T2 of the synchronizing signal, the bus control circuit 20 asserts the RAM selection signal (RAMCSX) and RAM read strobe signal (RAMREADX) on the memory bus 60. At this time, the ROM read strobe signal is negated by the bus control circuit 20. The bus control circuit 20 then outputs the address (RAM address) for the data read #2 to the memory bus 60.

Within the time of cycle T3, valid data VD#2 complying with the access request for the data read #2 is output from the RAM 40 to the memory bus 60. The valid data VD#2 is output to the data bus 52 by the bus control circuit 20.

At the rise of cycle T4 of the synchronizing signal, the transfer of the valid data VD#2 complying with the access request for the data read #2 is completed (the data read is completed). This completes the output of the address (RAM address) for the data read #2 to the data bus 52 by the CPU 10. Also, the output of the address (RAM address) for the data read #2 to the memory bus 60 by the bus control circuit 20 is completed. Further, since the wait time set for the ROM 30 in connection with the instruction fetch #1 expires, the bus control circuit 20 negates the wait signal on the instruction bus 51.

Within the time of cycle T4, a valid instruction VD#1 complying with the access request for the instruction fetch #1 is output from the ROM 30 to the memory bus 60. The valid instruction VD#1 is output to the instruction bus 51 by the bus control circuit 20.

Also, at the rise of cycle T4 of the synchronizing signal, an address for the data read #3 (access request for the RAM 40) is output from the CPU 10 to the data bus 52. At this point of time, the memory bus 60 is used for the instruction fetch. Namely, the access in compliance with the access request for the instruction fetch #1 is under execution. Accordingly, the access completion time of the instruction fetch #1 is compared with the access completion time of the data read #3.

The instruction fetch #1 requires four clock cycles and there is one more clock cycle remaining. Namely, the access completion time of the instruction fetch #1 is coincident with the rise of cycle T5 of the synchronizing signal. On the other hand, the data read #3 requires two clock cycles, that is, the completion time of the data read is coincident with the rise of cycle T6 of the synchronizing signal at the shortest.

Thus, as a result of the comparison of the access completion times by the completion time determination section 26, it is judged that the data read #3 cannot be completed earlier. At the rise of cycle T5 of the synchronizing signal, therefore, the wait signal on the data bus 52 is asserted by the bus control circuit 20.

Also, at the rise of cycle T5 of the synchronizing signal, the transfer of the valid instruction VD#1 complying with the access request for the instruction fetch #1 is completed (instruction fetch is completed). This completes the output of the address (ROM address) for the instruction fetch #1 to the instruction bus 51 by the CPU 10. Also, the bus control circuit 20 completes the output of the address (ROM address) for the instruction fetch #1 to the memory bus 60, and outputs instead the address (RAM address) for the data read #3 to the memory bus 60. Further, the bus control circuit 20 negates the ROM selection signal (ROMCSX) and the ROM read strobe signal (ROMREADX) and asserts the RAM selection signal (RAMCSX) and the RAM read strobe signal (RAMREADX), all on the memory bus 60.

Within the time of cycle T6, valid data VD#3 complying with the access request for the data read #3 is output from the RAM 40 to the memory bus 60. The valid data VD#3 is output to the data bus by the bus control circuit 20.

At the rise of cycle T7 of the synchronizing signal, the transfer of the valid data VD#3 complying with the access request for the data read #3 is completed, whereupon the output of the address for the data read #3 to the data bus 52 by the CPU 10 is completed. Simultaneously, the output of the address for the data read #3 to the memory bus 60 by the bus control circuit 20 is completed. Also, the RAM selection signal (RAMCSX) and the RAM read strobe signal (RAMREADX) are negated by the bus control circuit 20.

The above processing can be summarized as follows: When the access request for the data read #2 is output during the process of the instruction fetch #1, the bus control circuit 20 judges that the access request for the data read #2 can be completed earlier. Accordingly, the bus control circuit 20 once deactivates the ROM read strobe signal (ROMREADX), and then starts to access the RAM 40 for the data read #2. On completion of the access to the RAM 40, the bus control circuit 20 again activates the ROM read strobe signal (ROMREADX) which has been deactivated. At the end of cycle T4 thereafter, the valid data VD#1 is fetched.

The data read #3 starts from the cycle T4, but since the completion time of the instruction fetch is earlier, the access for the data read is deferred for a wait time corresponding to one cycle. Upon completion of the instruction fetch #1, the data read #3 is performed and completed in two cycles.

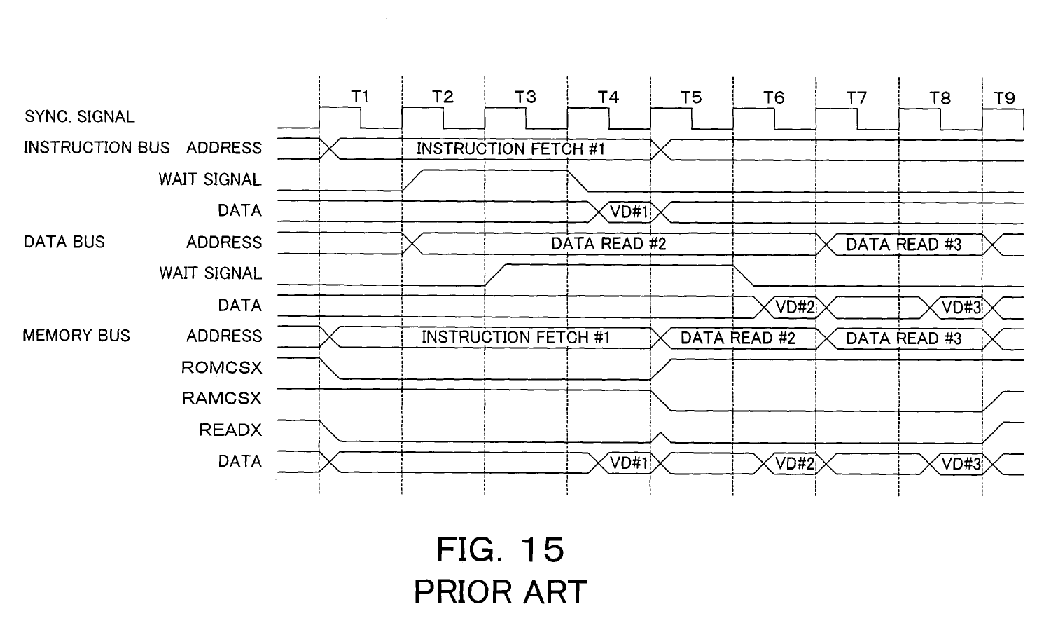

In this manner, one instruction fetch and two data reads can be completed in six cycles, shorter by a time corresponding to two cycles than in the example of FIG. 15 illustrating the conventional technique.

[A plurality of access requests are output simultaneously.]

In the first embodiment, when a plurality of access requests are output simultaneously, the bus control circuit 20 starts to process an access request requiring a longer access time preferentially over others. If a second access can be completed earlier before the access initiated first is completed, the bus control circuit 20 allows the second access to interrupt before completion of the first-initiated access. The term “simultaneously” means herein “within an identical cycle.”

The following describes the process performed by the bus control circuit 20 when a plurality of access requests are output simultaneously.

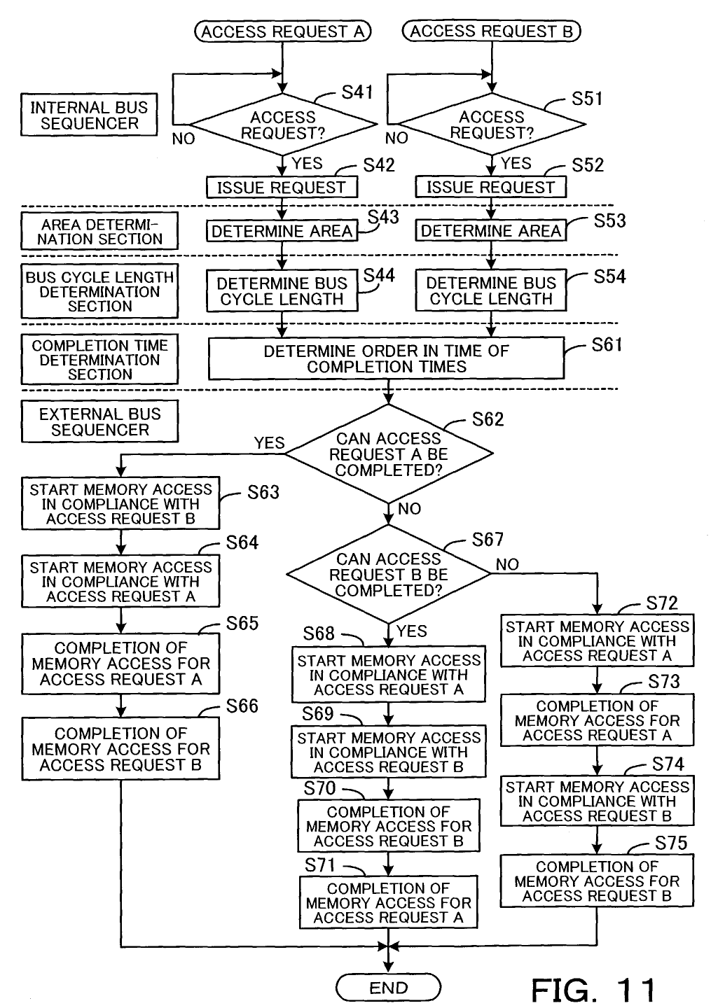

FIG. 11 is a flowchart illustrating the process executed when a plurality of access requests are output simultaneously. The process shown in FIG. 11 will be described in order of step number. In the following, it is assumed that an “access request A” and an “access request B” are output simultaneously from the CPU 10.

Steps S41 to S44 are identical with Steps S11 to S14 shown in FIG. 9, and Steps S51 to S54 are identical with Steps S21 to S24 shown in FIG. 9. Accordingly, Step S61 and the subsequent steps will be explained below.

[Step S61] Since a plurality of bus cycle lengths have been received within one cycle, the completion time determination section 26 recognizes that a plurality of access requests have been output simultaneously. Thus, the completion time determination section 26 compares the bus cycle lengths for the access requests A and B with each other. Based on the result of comparison, the completion time determination section 26 determines the relation of order in time between the completion times of the access requests A and B. The completion time determination section 26 further determines which of the access requests can be completed earlier if the access request with a shorter completion time is started one cycle after the start of the access request with a longer completion time. Namely, the completion time determination section 26 determines whether or not the access request with a shorter bus cycle length can be completed earlier than the other access request even if started one cycle later than the other access request. Then, the completion time determination section 26 transfers the result of determination to the external bus sequencer 22.

The determination result can be one of the following three:

The access request A is longer in bus cycle length, and the process in compliance with the access request B can be completed earlier than the access request A even if started after the process in compliance with the access request A is started (The access request B can be completed during the processing cycle of the access request A);

The access request B is longer in bus cycle length, and the process in compliance with the access request A can be completed earlier than the access request B even if started after the process in compliance with the access request B is started (The access request A can be completed during the processing cycle of the access request B); and

If, after the start of the process in compliance with one access request, the process in compliance with the other access request is started, the process in compliance with the other access request cannot be completed earlier than the process in compliance with the one access request.

[Step S62] The external bus sequencer 22 determines whether or not the received determination result shows that the access request A can be completed during the process of the access request B. If such a determination result has been received, the process proceeds to Step S63; if not, the process proceeds to Step S67.

[Step S63] The external bus sequencer 22 starts memory access in compliance with the access request B.

[Step S64] The external bus sequencer 22 starts memory access in compliance with the access request A.

[Step S65] The external bus sequencer 22 completes the memory access in compliance with the access request A, whereupon the instruction code or data is transferred from the external bus sequencer 22 to the internal bus sequencer 21. Then, the instruction code or data is transferred from the internal bus sequencer 21 to the CPU 10 through the instruction bus 51 or the data bus 52.

[Step S66] The external bus sequencer 22 completes the memory access in compliance with the access request B. The acquired instruction code or data is transferred to the CPU 10 in the same manner as explained above in Step S65.

[Step S67] The external bus sequencer 22 determines whether or not the received determination result shows that the access request B can be completed during the process of the access request A. If such a determination result has been received, the process proceeds to Step S68; if not, the process proceeds to Step S72.

[Step S68] The external bus sequencer 22 starts memory access in compliance with the access request A.

[Step S69] The external bus sequencer 22 starts memory access in compliance with the access request B.

[Step S70] The external bus sequencer 22 completes the memory access in compliance with the access request B. The acquired instruction code or data is transferred to the CPU 10 in the same manner as explained in Step S65.

[Step S71] The external bus sequencer 22 completes the memory access in compliance with the access request A. The acquired instruction code or data is transferred to the CPU 10 in the same manner as explained in Step S65, whereupon the process is ended.

[Step S72] The external bus sequencer 22 starts memory access in compliance with the access request A.

[Step S73] The external bus sequencer 22 completes the memory access in compliance with the access request A. The acquired instruction code or data is transferred to the CPU 10 in the same manner as explained in Step S65.

[Step S74] The external bus sequencer 22 starts memory access in compliance with the access request B.

[Step S75] The external bus sequencer 22 completes the memory access in compliance with the access request B. The acquired instruction code or data is transferred to the CPU 10 in the same manner as explained in Step S65, whereupon the process is ended.

Thus, if, during the process of an access request having a longer bus cycle length (requiring a longer memory access time), another access request can be completed, the process in compliance with the latter access request having a shorter bus cycle length is allowed to interrupt the process in compliance the former access request having a longer bus cycle length.

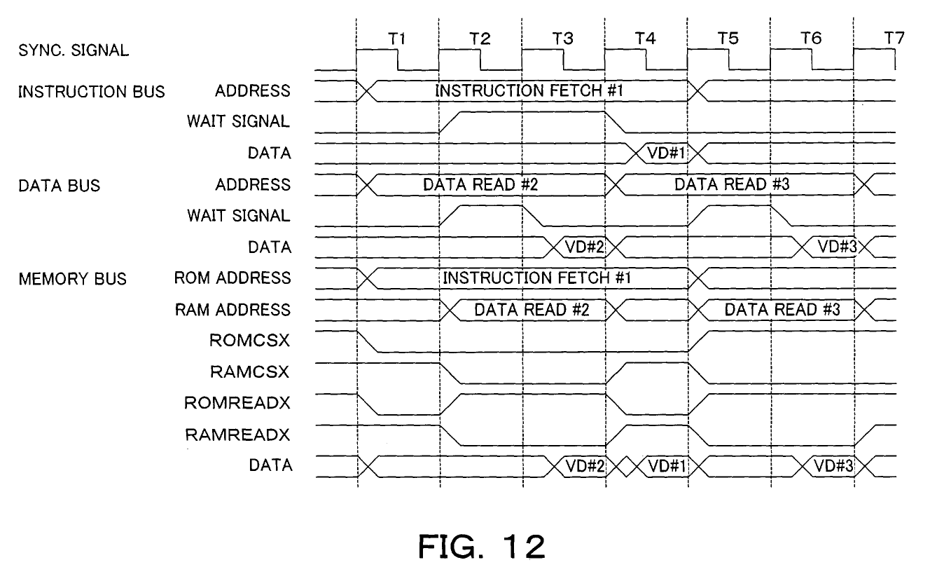

FIG. 12 is a timing chart showing the case where a plurality of access requests are output simultaneously.

In the example shown in FIG. 12, it is assumed that an access request for an instruction fetch #1 from the ROM 30 and an access request for a data read #2 from the RAM 40 are output simultaneously (within the same cycle) from the CPU 10, and that an access request for a data read #3 from the RAM 40 is output thereafter from the CPU 10.

First, at the rise of cycle T1 of the synchronizing signal, an address for the instruction fetch #1 (access request for the ROM 30) is output from the CPU 10 to the instruction bus 51. Simultaneously, an address for the data read #1 (access request for the RAM 40) is output from the CPU 10 to the data bus 52.

Thereupon, the bus control circuit 20 compares the bus cycle lengths of the two access requests with each other, and decides that the instruction fetch #1 with a longer bus cycle length (four cycles) should be started first.

Further, the bus control circuit 20 compares the access completion time of the instruction fetch #1 with an access completion time at which the access for the data read #2 will be completed if started in next cycle T2. The instruction fetch #1 requires four clock cycles and thus the access completion time thereof is coincident with the rise of cycle T5 of the synchronizing signal. On the other hand, the data read #2 requires two clock cycles and thus the data read completion time is coincident with the rise of cycle T4 of the synchronizing signal. As a result of the comparison of the access completion times by the completion time determination section 26, therefore, it is judged that the data read #2 can be completed earlier. Namely, a decision is made that the access for the data read #2 should be performed during the period of cycles T2 to T4.

Accordingly, in cycle T1, the address (ROM address) for the instruction fetch #1 is output from the bus control circuit 20 to the memory bus 60. At this time, the ROM selection signal (ROMCSX) on the memory bus 60 is asserted by the bus control circuit 20; but since the access for the data read #2 is to interrupt the instruction fetch, the ROM read strobe signal (ROMREADX) is left negated.

At the rise of cycle T2 of the synchronizing signal, the wait signal on the instruction bus 51 is asserted by the bus control circuit 20. Also, to permit the interrupt of the access for the data read #2, the RAM selection signal (RAMCSX) and RAM read strobe signal (RAMREADX) on the memory bus 60 are asserted by the bus control circuit 20. Since the data read #2 is started with a delay of one cycle, moreover, the wait signal on the data bus 52 is asserted by the bus control circuit 20. Then, the bus control circuit 20 outputs the address (RAM address) for the data read #2 to the memory bus 60.

The processing performed in and after cycle T3 is identical with that performed in and after cycle T3 in the timing chart shown in FIG. 10.

In this manner, if, in cycle T1, the instruction fetch #1 and the data read #2 are simultaneously requested by the CPU 10, the bus control circuit 20 judges that the completion time of the instruction fetch #1 is later than that of the data read #2. Then, the bus control circuit 20 starts memory access for the instruction fetch #1 in cycle T1 and starts memory access for the data read #2 in cycle T2, whereby the access for the data read #2 is completed at the rise of cycle T4 of the synchronizing signal while the access for the instruction fetch #1 is completed at the rise of cycle T5 of the synchronizing signal.

As a result, one instruction fetch and two data reads can be completed in six cycles. With the conventional technique, when a plurality of access requests are output simultaneously, the accesses are processed simply in order of occurrence, requiring the time as shown in the example of FIG. 15. Compared with the example of FIG. 15, therefore, the example of FIG. 12 can shorten the required time by two cycles.

As described above, in the first embodiment of the present invention, if it is judged that before completion of a first-initiated memory access, a second memory access can be completed, the second memory access is performed during the first-initiated memory access. This permits efficient access to a plurality of memories with different access speeds.

[Second Embodiment]

A second embodiment will be now described. In the second embodiment, the present invention is applied to an electronic device having a multi-CPU configuration.

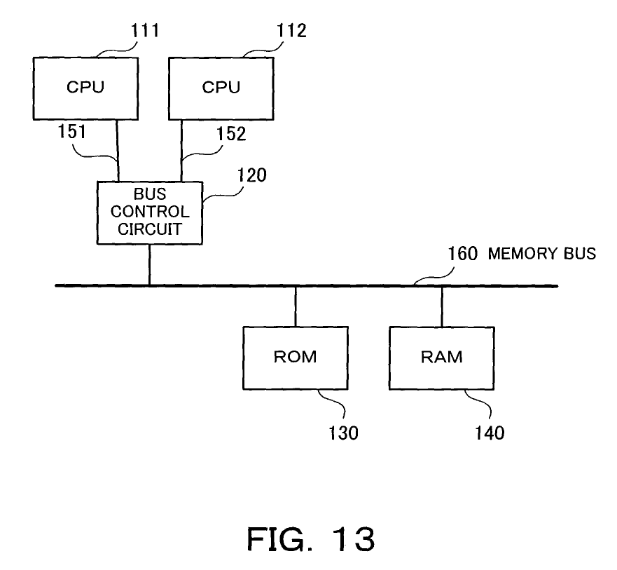

FIG. 13 shows an exemplary hardware configuration of an electronic device according to the second embodiment. As shown in FIG. 13, the second embodiment comprises a plurality of CPUs 111 and 112, a bus control circuit 120, a ROM 130, a RAM 140, a plurality of internal buses 151 and 152, and a memory bus 160.

The CPU 111 is connected to the bus control circuit 120 through the internal bus 151, while the CPU 112 is connected to the bus control circuit 120 through the other internal bus 152. The CPUs 111 and 112 play the respective roles in data processing and each execute data processing allotted thereto. The CPU 111 accesses the ROM 130 or the RAM 140 via the internal bus 151, the bus control circuit 120 and the memory bus 160 to perform instruction fetch or data read. Similarly, the CPU 112 accesses the ROM 130 or the RAM 140 via the internal bus 152, the bus control circuit 120 and the memory bus 160 to perform instruction fetch or data read.

In response to an access request from the CPU 111 or 112, the bus control circuit 120 acquires an instruction code or data from the ROM 130 or the RAM 140. Then, the bus control circuit 120 transfers the acquired instruction code or data to the corresponding CPU from which the access request has been output.

If access requests for the ROM 130 or the RAM 140 are output from the respective CPUs 111 and 112 in such a manner as to overlap in a certain period of time, the bus control circuit 120 makes a determination as to contention between the access instructions. If, as a result of the determination as to contention, it is judged that the access requests have been output simultaneously from the CPUs 111 and 112, the bus control circuit 120 determines timings for starting the processes in compliance with the respective access requests, based on the access completion times of the respective access requests. Then, the bus control circuit 120 accesses the ROM 130 or the RAM 140 in accordance with the determined timings.

The bus control circuit 120 has an internal configuration almost identical with that of the bus control circuit 20 of the first embodiment shown in FIG. 5. The former differs from the latter in that the internal buses 151 and 152 are connected to the internal bus sequencer of the bus control circuit 120.

The ROM 130, RAM 140 and memory bus 160 shown in FIG. 13 have functions identical with those of the respective elements (ROM 30, RAM 40, memory bus 60) of the first embodiment shown in FIG. 4.

By using the hardware configuration described above, it is possible to enhance the memory access efficiency of an electronic device having a multi-CPU configuration. For example, while the CPU 111 is performing an instruction fetch from the ROM 130 (during the processing cycle of access), a data read from the RAM 140 requested by the CPU 112 can be performed.

[Third Embodiment]

A third embodiment will be now described. The third embodiment is applied to the case where the memory used has no address latch circuit built therein. In the first and second embodiments, the memory (ROM 30, 130) with a relatively low access speed has a built-in address latch circuit. However, not all types of ROM have an address latch circuit built therein. Accordingly, in the case of a system using a ROM with no built-in address latch circuit, an address latch circuit is provided between the ROM and the memory bus.

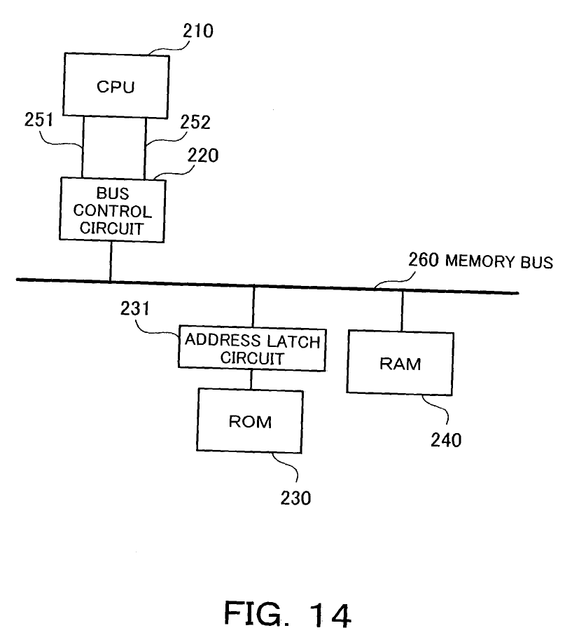

FIG. 14 shows an exemplary hardware configuration of an electronic device according to the third embodiment. As shown in FIG. 14, the third embodiment comprises a CPU 210, a bus control circuit 220, a ROM 230, an address latch circuit 231, a RAM 240, an instruction bus 251, a data bus 252, and a memory bus 260. These elements except the ROM 230 and the address latch circuit 231 have functions identical with those of the respective elements of the first embodiment shown in FIG. 4.

The ROM 230 functions basically in the same manner as the ROM 30 of the first embodiment shown in FIG. 4 but does not have the function of latching an address. In the third embodiment, therefore, the address latch circuit 231 is provided between the ROM 230 and the memory bus 260.

The address latch circuit 231 has a circuit built therein for latching an address (temporarily holding data) output onto the address signal line of the memory bus 260. Specifically, when the selection signal for the ROM 230 is activated, the address latch circuit 231 latches the address output to the address signal line. The ROM 230 accesses data at the address latched by the address latch circuit 231. Even if the address output to the address signal line of the memory bus 260 changes before completion of the access, the ROM 230 can continue the data access based on the address latched by the address latch circuit 231.

[Other Embodiments]

In the description of the foregoing embodiments, targets of access from the CPU(s) are semiconductor memories such as ROM and RAM, but the targets of access are not limited to ROM or RAM and may be I/O (Input/Output) devices, for example. I/O devices are devices for inputting or outputting data. Input devices include a mouse and a keyboard, while output devices include a printer and a display.

As described above, in accordance with the first, third and fifth modes of the present invention, if, during an access in compliance with a first access request, a second access request is issued, the relation of order in time between their access completion times is determined. If it is judged that the access in compliance with the second access request can be completed earlier than the currently performed access, the access in compliance with the second access request is performed during the processing cycle of the access in compliance with the first access request. Consequently, processes in compliance with a plurality of access requests are performed in such a manner as to overlap in time, whereby the bus access efficiency can be enhanced.

Also, in accordance with the second, fourth and sixth modes of the present invention, if a plurality of access requests are issued simultaneously, the relation of order in time between the completion time of an access to be performed first and the completion time of an access to be performed later is determined. If it is judged that the access to be performed later can be completed earlier than the completion time of the access to be performed first, the access in compliance with the second access request to be initiated later is performed during the processing cycle of the access in compliance with the first access request initiated first. Consequently, processes in compliance with a plurality of access requests issued simultaneously are performed in such a manner as to overlap in time, whereby the bus access efficiency can be enhanced.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A microcomputer for accessing a plurality of devices through a shared bus, comprising:
an access completion time determination section for determining a relation of order in time between a time of completion of access to a first device and an earliest time at which access to a second device can be completed, based on required access times for the first and second devices when, during access to the first device in compliance with a first access request, a second access request for the second device is issued from a CPU; and
a bus access section for performing the access to the second device in compliance with the second access request during a processing cycle of the access to the first device in compliance with the first access request if it is judged by said access completion time determination section that the access to the second device can be completed earlier than the completion time of the access to the first device.

2. The microcomputer according to claim 1, wherein said plurality of devices comprise a plurality of semiconductor memories having different required access times.

3. The microcomputer according to claim 1, wherein said plurality of devices comprise a plurality of I/O devices having different required access times.

4. The microcomputer according to claim 1, further comprising:
a wait setting register in which are set in advance output times for a wait signal to be output to the CPU when the first and second devices are accessed; and
an access time determination section for determining the required access times for the first and second access requests based on the output times of the wait signal set in said wait setting register.

5. The microcomputer according to claim 4, wherein said access completion time determination section holds access completion time information indicating a time left before completion of the access to the first device in compliance with the first access request, and compares the access completion time information with the required access time for the second access request determined by said access time determination section, to determine the relation of order in time between the completion time of the access to the first device and the earliest time at which the access to the second device can be completed.

6. The microcomputer according to claim 1, wherein said first access request is an instruction fetch request output from the CPU through an instruction bus, and said second access request is a data read request output from the CPU through a data bus.

7. The microcomputer according to claim 1, wherein said first and second access requests are output from a plurality of CPUs, respectively.

8. A microcomputer for accessing a plurality of devices through a shared bus, comprising:
an access completion time determination section, responsive to simultaneous issuance of a plurality of access requests for different devices from a CPU, for determining, based on required access times for the individual devices, a relation of order in time between an earliest time at which access to a first device to be accessed in advance can be completed and an earliest time at which access to a second device to be accessed later can be completed; and
a bus access section for starting the access to the first device and then performing the access to the second device during a processing cycle of the access to the first device if it is judged by said access completion time determination section that the access to the second device can be completed earlier than the completion time of the access to the first device.

9. The microcomputer according to claim 8, wherein, when a plurality of access requests are issued simultaneously, said access completion time determination section determines an access order such that access to a device with a longer required access time is started in advance.

10. A bus control circuit for accessing a plurality of devices through a shared bus in response to requests from a CPU, comprising:
an access completion time determination section for determining a relation of order in time between a time of completion of access to a first device and an earliest time at which access to a second device can be completed, based on required access times for the first and second devices when, during access to the first device in compliance with a first access request, a second access request for the second device is issued from the CPU; and
a bus access section for performing the access to the second device in compliance with the second access request during a processing cycle of the access to the first device in compliance with the first access request if it is judged by said access completion time determination section that the access to the second device can be completed earlier than the completion time of the access to the first device.

11. A bus control circuit for accessing a plurality of devices through a shared bus in response to requests from a CPU, comprising:
an access completion time determination section, responsive to simultaneous issuance of a plurality of access requests for different devices from the CPU, for determining, based on required access times for the individual devices, a relation of order in time between an earliest time at which access to a first device to be accessed in advance can be completed and an earliest time at which access to a second device to be accessed later can be completed if the accesses to the devices are started in order of length of the required access time; and
a bus access section for starting the access to the first device and then performing the access to the second device during a processing cycle of the access to the first device if it is judged that the access to the second device can be completed earlier than the completion time of the access to the first device.

12. A data access method for a microcomputer for accessing a plurality of devices through a shared bus, comprising:
determining a relation of order in time between a time of completion of access to a first device and an earliest time at which access to a second device can be completed, based on required access times for the first and second devices when, during access to the first device in compliance with a first access request, a second access request for the second device is issued from a CPU; and
performing the access to the second device in compliance with the second access request during a processing cycle of the access to the first device in compliance with the first access request if it is judged that the access to the second device can be completed earlier than the completion time of the access to the first device.

13. A data access method for a microcomputer for accessing a plurality of devices through a shared bus, comprising:
determining, in response to simultaneous issuance of a plurality of access requests for different devices from a CPU and based on required access times for the individual devices, a relation of order in time between an earliest time at which access to a first device to be accessed in advance can be completed and an earliest time at which access to a second device to be accessed later can be completed; and
starting the access to the first device and then performing the access to the second device during a processing cycle of the access to the first device if it is judged that the access to the second device can be completed earlier than the completion time of the access to the first device.
